(19) United States
(12) Patent Application Publication
(10) Pub. No.: US 2018/0131080 A1
(43) Pub. Date: May 10, 2018

(54) BODY-WEARABLE ANTENNA SYSTEM

(71) Applicant: THE SECRETARY OF STATE FOR DEFENCE, SALISBURY, WILTSHIRE (GB)

(72) Inventor: STEPHEN JOHN BOYES, SALISBURY (GB)

(73) Assignee: THE SECRETARY OF STATE FOR DEFENCE, SALISBURY, WILTSHIRE (GB)

(21) Appl. No.: 15/572,308

(22) PCT Filed: Jun. 3, 2016
(86) PCT No.: PCT/GB2016/000111

§ 371 Date: Nov. 7, 2017

(30) Foreign Application Priority Data
Jun. 12, 2015 (GB) 1510487.0

(51) Int. Cl. H01Q 1/27; H01Q 3/34; H01Q 21/06

(52) U.S. Cl. CPC H01Q 1/273; H01Q 21/067; H01Q 21/062; H01Q 3/34

(57) ABSTRACT

A body-wearable antenna system is described that comprises at least two antenna elements (2, 4) arranged to be mountable in a substantially equi-spaced distributed array around a user's body. Each antenna element is a directional type antenna and the antenna system is configurable such that when worn the antenna elements operate in phase to deliver a combined, higher gain, omnidirectional performance radiating away from the user's body, compared to one or more conventional body-worn omnidirectional antennas. The antenna system can operate in transmit and receive. Each antenna element may be a planar inverted-F antenna (PIFA) housed in a protective radome (3, 5). Each PIFA may feature at least one slot cut into the radiating top plate or at least one parasitic radiator, or a combination of both, to allow operation within distinct frequency bands and with predetermined impedance bandwidth.

### TECHNICAL FIELD OF THE INVENTION

This invention relates to a body-wearable antenna system, and particularly to a body-wearable antenna system capable of providing improved radiation efficiency in an omnidirectional Manner.

### BACKGROUND TO THE INVENTION

Body-wearable antennas are now well known for transmitting and receiving signals for various Radio Frequency (RF) applications including communications. The primary advantage being that the user can remain essentially “hands-free” and maintain a high degree of freedom of movement. For certain applications, particularly, but not exclusively, applicable to search and rescue, security and military services, it is necessary to provide omnidirectional performance in both transmit and receive mode. This can be achieved using conventional monopole, dipole and planar type structures.

For example US 2004/0004573 (Apostolos) describes a direction finding system using body-worn antennas, wherein the direction of a source of electromagnetic radiation can be determined by means of a plurality of direction finding antennas connected to a direction finding module.

However, use of omnidirectional antennas in body-worn applications leads to a number of issues due to the proximity of the human body. In particular, input power is limited owing to legal radiation hazard constraints and absorption and dissipation by the body will decrease the antennas' efficiency and distort radiation patterns; detuning issues are also widely reported. Furthermore, aspects which affect user comfort must also be considered; such as size, weight, profile and positioning. These aspects can affect the user's freedom of manoeuvre, which, in turn, may have an impact on the user's ability to complete a given task. For example, an antenna which protrudes above the user's head is liable to restrict movement as a result of snagging.

It is therefore an aim of the invention to provide a body-wearable antenna system having omnidirectional coverage, with improved high gain technical performance combined with a discreet design and increased user comfort.

### SUMMARY OF THE INVENTION

According to the invention there is provided a body-wearable antenna system capable of operating in transmit and receive, comprising at least two antenna elements arranged to be mountable in a substantially equi-spaced distributed array around a user's body, wherein each antenna element is a directional type antenna and wherein the antenna system is configured, in use, such that the antenna elements operate in phase with each other to deliver a combined, higher gain, omnidirectional performance radiating away from the user's body, compared to one or more conventional body-worn omnidirectional antennas.

When omnidirectional antenna elements are mounted on a user's body, some power will be absorbed and dissipated by the body, causing shadowing effects or drops in radiated power in certain directions. To attempt to mitigate these undesirable effects, a body-worn omnidirectional antenna is sometimes carried in a backpack, worn by the user, so that the antenna protrudes over the user's head. However, omnidirectional antennas, by their very nature, exhibit finite and lower gain values than can be achieved using directional antennas.

“Antenna gain” or “gain” is generally understood to be the ratio of the radiation intensity in a given direction from the antenna to, the total input power accepted by the antenna divided by 4π. The antenna gain is a function of both an antenna's directivity and radiation efficiency. It is an important parameter because it governs the amount of power at a given receiver under line of sight conditions. The radiation pattern of an antenna is also important to consider as it describes the nature/behaviour of how power is transferred and distributed into free space from the antenna element. Higher gain antennas are directive in terms of their radiation pattern.

Use of a plurality of directional antenna elements that are substantially equi-spaced) around the user's body and operated in-phase with each other can deliver a combined omnidirectional performance that provides an improved power delivery mechanism, providing higher gain performance than one or more conventional body-worn omnidirectional antennas., The gain of the antenna system is increased simply by migrating to a suitably designed directional antenna element strategy, wherein each antenna element has a radiation pattern such that, when all antenna elements in the antenna system are combined and operated in-phase with each other, provides the overall omnidirectional performance of the antenna system. A person skilled in the art will realise that for directional antenna elements as the desired frequency of operation is changed, the respective radiation pattern may also change. The beam-width for a particular antenna element may be narrower at certain frequencies than at others, thereby requiring more of said directional antenna elements to achieve omnidirectional coverage. When two directional antenna elements, with appropriate respective radiation patterns, are equally distributed around a user's body, the radiated power is directed away from the body allowing stronger concentrations of power to be formed substantially all around the user, when compared to using one or more omnidirectional antenna elements, thereby minimising shadowing effects. If only two antenna elements are used it will be understood that an appropriate antenna element radiation pattern cannot be overly directional, since power will need to be radiated in all directions from around the user's body. Alternatively a distributed array comprising more than two directional antenna elements may be used.

The antenna elements are individual parts of the overall antenna system, which are used in conjunction with one another to collectively send or receive a signal, providing consistent panoramic coverage for 360 degrees around in azimuth. In order to achieve an overall omnidirectional performance radiating away from the user's body using a plurality of directional antenna elements, it is necessary to control the radiation pattern of each antenna element.

Increasing the gain of a body-wearable antenna system in accordance with the invention has the added benefit that the size, weight and power of any equipment supplying the antenna system can be reduced. Since the amount of power evident at a receiver with any line of sight component is directly proportional to the gain of the transmitting antenna, an increase in gain will effectively mean that the input power required by the transmitting antenna can be reduced for a constant power at the receiver. A consequence of reduced input power requirement is that the battery size and weight can be reduced thereby lightening the load that needs to be carried. Alternatively, the directional nature of the antenna elements allows for greater input power and hence higher radiated power (for a constant gain level) since the radiation hazard (in the form of Specific Absorption Ratio (SAR) to the user can be reduced; this results from any power being purposely directed away from the body.

In accordance with this invention, the inventor has created a capability which uses at least two directional antennas that is able to distribute power through “high gain” radiation patterns, in all azimuth directions, whilst potentially reducing the burden for the user.

Preferably the antenna elements are planar type antennas comprising a radiating top plate and a ground plane. The planar approach has the advantage of reducing the profile, and also that planar antennas tend to be simple and cost effective to manufacture. However, many planar antennas, developed for Ultra Wideband (UWB) applications, exhibit omnidirectional radiation characteristics and the introduction of a large ground plane to reflect power in a directional manner can have the consequence of rendering the antenna acutely narrowband.

However, the Planar Inverted-F Antenna (PIFA) has been found to be configurable to provide the required frequency response and bandwidth together with optimum, impedance matching. The skilled person will understand a PIFA to generally comprise a radiating top plate and a ground plane connected by a feed and a shorting pin. The PIFA is generally lightweight, low-cost and low-profile and is well known from its adoption in mobile phones. However, by careful parameterisation, it is possible to configure a PIFA to operate in a directional manner in accordance with the invention across many different operational frequencies, not limited to the telecommunication assigned frequencies.

Chattha, H. T., Huang, Y., Ishfaq, M. K., and Boyes, S. J., “A comprehensive parametric study of planar inverted-F antenna”, SciRP Wireless Engineering and Technology, Vol. 3 No. 1, January 2012, proposed the following equation for characterising the PIFA antenna:

f_{c}=c/(3W+5.6L+3.7h−3W_{f}−3.7Wₛ−4.3L_{b}−2.5Lₛ) (1)

where f_{c} is the resonant centre frequency, c is the speed of light in a vacuum≈3×10⁸ m/s, W, L and h are the width, length and height of the top plate respectively; W_{f} and Ws are the widths of the feed and shorting structures; L_{b} is the horizontal distance between these structures and Ls is the distance of the shorting structure from the side edge of the ground plane.

Using general principles and Equation 1 to parameterise the PIFA it is possible to vary one parameter at a time to optimise the topology to provide the desired performance. It is generally understood that:
The larger the length of the ground plane, the lower the resonant frequency.
The larger the length of the ground plane, the wider the fractional bandwidth.
Positioning the radiating top plate right at the edge of the ground plane provides a higher fractional bandwidth and the lowest resonant frequency.
The larger the length of the radiating top plate L, the lower the resonant frequency.
The larger the width of the radiating top plate W, the lower the resonant frequency.
The larger the height h between the ground plane and the radiating top plate, the lower the resonant frequency and the larger the bandwidth.
The position of the shorting pin at the corner edge of the ground plane gives rise to the lowest resonant frequency.
The smaller the width of the shorting pin Wₛ, the lower the resonant frequency and the larger the fractional bandwidth.
The larger the feed width W_{f}, the lower the resonant frequency and the larger the fractional bandwidth.

The radiating element of each PIFA may advantageously be configured to be triangular in shape. First and foremost, this allows the antenna to be operated across a range of different frequencies using a constant topology (albeit appropriately configured in size) from VHF up to X band and beyond. Secondly, when operating at VHF frequencies, the triangular shape allows for an increase in the electrical length of the radiating top plate in order to obtain the frequency bands of interest whilst allowing the design to remain as compact as possible, more so than for example, a rectangular top plate design can provide.

PIFA antenna elements can be configured to operate across continuous frequency ranges or in distinct bands of interest. For distinct bands, it is well known that in order to create additional working frequency bands from a single radiating element, different current path lengths can be created in order to control the surface current to “see” different electrical lengths. Therefore, as the surface current flows over two (or more) distinct paths each with a given electrical length, this will create a working band in the frequency domain corresponding to an approximate quarter wavelength dimension. This can be achieved by cutting at least one slot into the radiating top plate of the antenna element. The levels of impedance matching and specific frequencies in which the impedance matching is enacted are dependent on the lengths of the slot cut.

A person skilled in the art will be aware that the impedance bandwidth of an antenna can be increased through use of one or more parasitic radiators. In one embodiment of the invention at least one parasitic radiator is mounted on and connected to the ground plane of each PIFA. Each parasitic radiator is configured with pre-determined height, width and positioning on each of the PIFA elements.

Depending on the particular application each antenna element may be encased or embedded within a protective radome made, for example, from a hardened plastic. This will help to protect the antenna element from breakage or damage, for example, by abrasion against other surfaces. The radome itself should be transparent to electromagnetic waves in order not to impede the antenna element's performance. In order to allow the antenna element to be securely mounted in the radome the ground plane may be provided with mounting tabs.

Whilst the antenna elements may comprise rigid metal sheet material they may optionally be formed from flexible materials such as metal impregnated textiles. Flexible antenna elements may be particularly suitable for incorporation into a body wearable garment depending upon the intended application.

In order to power the antenna system each antenna element may be provided with an electrical conductor, such as a coaxial line, for electrically connecting the antenna element to a power source. Preferably, the power from a single power source can be used to power more than one antenna element in which case the power source is electrically connected to a power divider, which in turn, is electrically connected to at least two antenna elements. In the case of two distributed antenna elements a 2:1 power divider will be required. The power divider should exhibit a low insertion loss and needs to provide a zero degree phase (combination) capability in order for the radiation patterns of the individual antenna elements to combine constructively. Alternatively, each antenna element could be provided with its own power source subject to the specific application should this be desired.

Depending on the particular application being addressed, the antenna system may comprise one or more transceivers or separate transmitter or receiver circuitry connected to the antenna elements. Furthermore, a signal processing capability may be provided by the inclusion of a suitable signal processor unit.

For example, the antenna system may be configured to provide a diversity capability for use in the communications field to exploit the multipath behaviour in non-line of sight environments. As the antenna elements are designed and configured to point their main beams in different spatial directions, this antenna system can be used to provide ‘angle or pattern diversity’ which can be employed to increase data rates and combat any multipath fading that arises in the propagation channel. To achieve this, a comparator stage can be integrated into the receiver equipment and the provision of a signal processor allows for signal processing algorithms to be performed to enact the desired diversity scheme (i.e. selection combining, equal gain combining, maximal ratio combining etc.).

The antenna system may be mounted on or within a garment. For example the antenna elements can be inserted into at least a first and a second pocket or pouch substantially equi-spaced around the garment for mounting the antenna elements in the required distributed array. The antenna elements can be held securely using flaps provided with press studs, zip fasteners or equivalent fastening means when worn about the body. Alternatively, flexible antenna elements can be incorporated into the fabric of the garment. All electrical conductors, such as coaxial lines, should preferably be secured inside the garment or under straps so that they are secured against snagging. The power source may be located in a separate pouch mounted about the body or inside a backpack or Bergen.

If a backpack or Bergen is worn antenna element(s) are designed also to be mounted in the backpack facing outwards so that the backpack itself will not offer any shadowing on the radiation performance from the antenna element(s). The antenna elements inside a backpack or Bergen, which is then worn by the user, are still considered as body-wearable.

### BRIEF DESCRIPTION OF THE DRAWINGS

An embodiment of the invention will now be described by way of example only and with reference to the accompanying drawings, in which:

FIG. 1 shows a schematic diagram of an antenna system according to the invention;

FIG. 2a shows a plan schematic diagram of an antenna element for use in an antenna system according to the invention;

FIG. 2b shows aside view schematic diagram of an antenna element for use in an antenna system according to the invention;

FIG. 2c shows a rear view schematic diagram of an antenna element featuring an optional parasitic radiator, for use in an antenna system according to the invention;

FIG. 3 shows a schematic diagram of a garment incorporating an antenna system according to the invention;

FIG. 4a shows gain in the far field of operation for a conventional body wearable omnidirectional antenna;

FIG. 4b shows gain in the far field of operation for a body wearable antenna system according to the invention.

The drawings are purely illustrative and are not to scale. Same or similar reference signs denote same or similar features.

### DETAILED DESCRIPTION

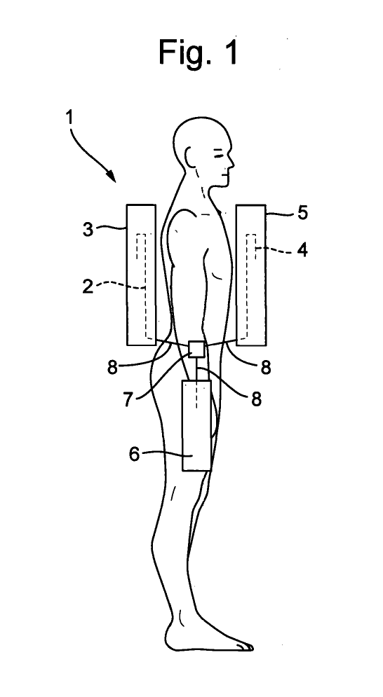

FIG. 1 shows, in schematic form, a person wearing an antenna system 1 in accordance with an embodiment of the invention. A first antenna element 2 is securely mounted within a first radome 3 and worn on the back of the user. A second antenna element 4 is mounted within a second radome 5 and worn on the front of the user. In this embodiment the antenna elements are in the form of PIFA. The radomes 3, 5 are made from a suitable hard plastics material, which is transparent to electromagnetic waves, in order to protect the antenna elements from damage during use. A series of mounting pillars is formed inside the radome to provide an elevated “pillar” that is drilled and tapped to suit an appropriate nylon screw, which is used to secure the PIFA firmly in position. Each antenna element 2, 4 is connected via a connector (not shown) to a coaxial cable 8 which electrically connects the antenna elements to a 2:1 zero degree phase power divider 7. A further coaxial cable 8 connects the power divider 7 to a power source which, in this case, is held within equipment casing 6. The equipment casing 6 is also mounted about, the body, secured and worn by appropriate means, and holds other essential circuitry, as well as a suitable battery.

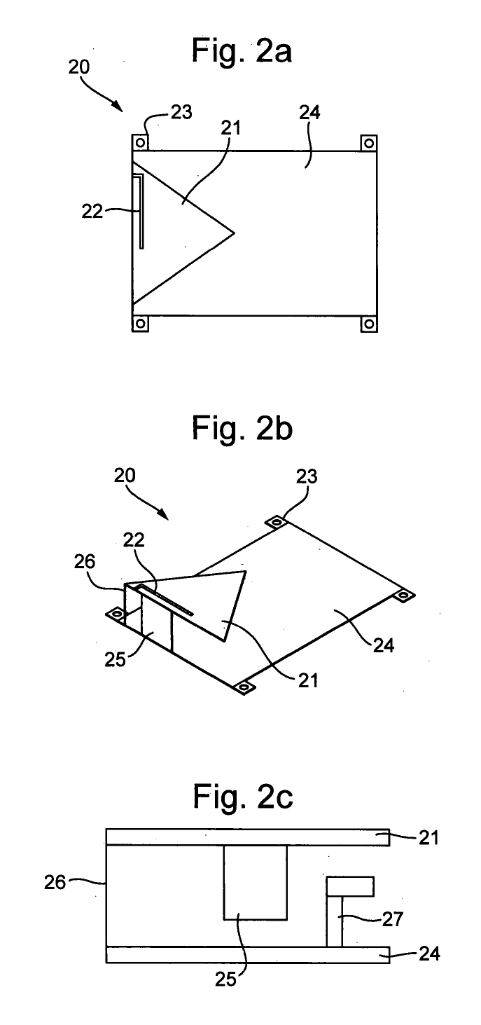

FIGS. 2a and 2b show an antenna element 20 in more detail. The antenna element is configured as a PIFA and comprises a radiating top plate 21, a ground plane 24, a feed plate 25 and a shorting pin 26. A dielectric medium, which in this case is air (not shown), is provided between the ground plane 24 and the radiating top plate 21. The PIFA is constructed from annealed copper having a thickness of 2 mm and a conductivity of 5.8×10⁷ S/m. The inherently large material conductivity ensures that the ohmic losses in the structure will be minimised, since theoretically, a higher material conductivity supports higher levels of antenna radiation efficiency. FIG. 2c is a rear view of an antenna element that shows the ground plane 24, feed plate 25, radiating top plate 21 and shorting pin 26. There is a gap provided between the feed plate 25 and the ground plane 24, in order to prevent shorting of the device. The dielectric in this gap is configured to be air (free space). Also shown is the placement of an optional parasitic radiator 27. The parasitic radiator is mounted on and connected to the ground plane 24 of the PIFA, with a proximity to the feed plate 25 that is pre-determined. There may be more than one parasitic radiator placed on each PIFA. The parasitic radiator 27 is shown to be ‘L’ shaped but is not limited to this form. A person skilled in the art will understand that the length of a parasitic radiator is one-quarter the primary wavelength of the PIFA. Therefore the use of a parasitic radiator may be determined by the practicality of mounting the radiator on the PIFA.

Depending on the dimensions of the radiating top plate 21, a supporting structure (not shown) is sometimes required to hold the top plate fixed relative to the ground plane. This can be formed by the use of a simple non-metallic cylinder (for example a nylon material) that is connected between the radiating top plate 21 and the ground plane 24 by the use of non-metallic screws. Alternatively, if the dielectric medium is a solid material this can be used to provide support for the radiating top plate 21.

The radiating top plate 21 is triangular in shape. This allows for both the length L and width W of the radiating top plate 21 to be optimised for the desired operating frequency, whilst the overall size and weight of the top plate is kept to a minimum.

The antenna element shown in FIG. 2 is designed to incorporate a dual band capability that is provided by the electrical length of the triangular top plate 21 (band 1) and the provision of the slot 22 cut into the radiating top plate 21 (band 2). However, the skilled person will understand that a continuous (wide) frequency capability may be formed off the topology by use of parasitic resonators and/or multiple resonant structures for example if wider frequencies are desired.

Mounting tabs 23 are situated on each corner of the ground plane 24 for cooperation with the mounting pillars in the radome, so that the antenna element 20 can be held firmly inside a purpose built radome, such as 3, 5 in FIG. 1.

The antenna element 20 is driven by an appropriate connector (not shown) which is secured to the feed plate 25, which in turn is directly connected to the radiating top plate 21.

As the antenna elements are directional, radiating away from the human bearer, the front and back radiating top plates 21 can be located closer to the skin, without significantly compromising their performance, compared to conventional omnidirectional body worn antenna types. It has been found in this work that both antennas remain significantly impedance matched with no frequency shifts being evident despite being electrically close to, the human bearer. This is important because it shows that the body is not interacting significantly with the antennas to disturb their performance, which is brought about because reduced amounts of radiated power is being intentionally directed into the human body. The two antennas are also sufficiently decoupled that significant power losses through mutual coupling are avoided because the antennas are directional and have their main beams pointing in different spatial directions.

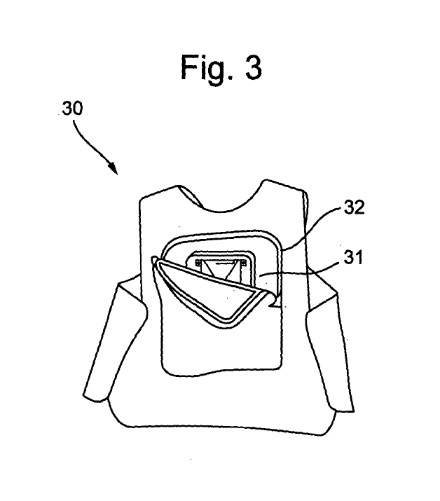

FIG. 3 shows a protective vest 30 having a front pouch or pocket 32 in which the front antenna element protected within a radome 31 may be housed and secured when worn about the body. A similar pouch or pocket is provided on the back of the vest for housing the back antenna element.

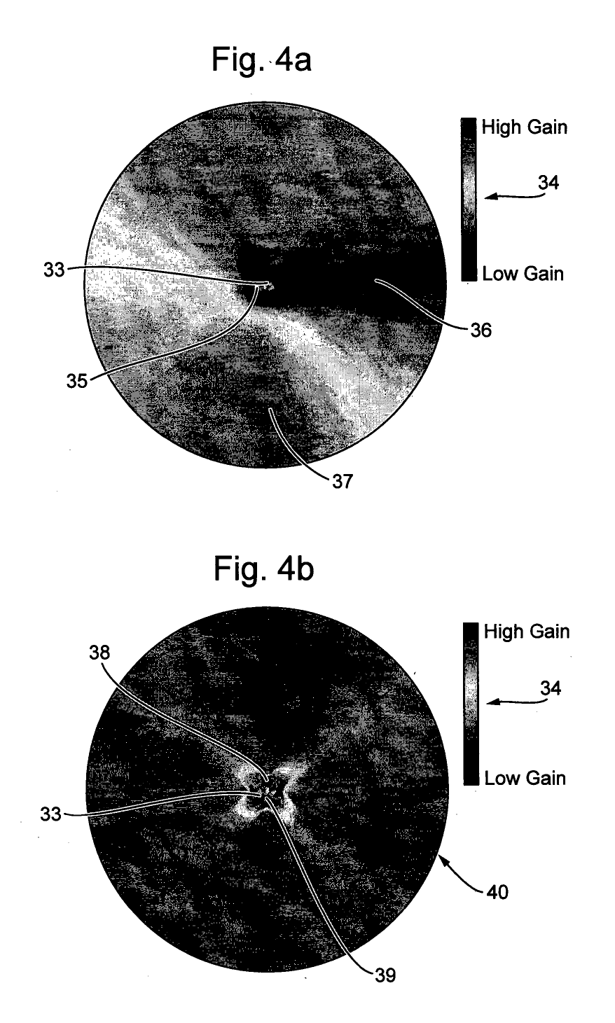

FIG. 4a and FIG. 4b are provided for indication only and show respective plots of gain in the far field of operation for a single conventional omnidirectional antenna, and an antenna system according to the invention, mounted on the user 33. A scale 34 is provided in order to indicate regions of relatively high gain and regions of relatively low gain. In FIG. 4a the omnidirectional antenna 35 is mounted on the back left of the user 33. The figure shows the shadowing effect of the user's body 33, evidenced by the low gain region 36 on the substantially opposite side of the user to the antenna. The region of relatively high gain 37 is concentrated in the substantially rearwards direction relative to the user 33. This configuration offers relatively poor omnidirectional performance. In FIG. 4b the antenna system of the invention comprises first and second PIFA directional antenna elements. The first antenna element 38 is mounted on the front of the user 33, the second antenna element 39 is mounted on the rear of the user 33. FIG. 4b shows that overall antenna system performance 40 is improved relative to FIG. 4a. Gain values are relatively high in substantially all directions, thereby achieving superior omnidirectional performance.

Further embodiments falling within the scope of the appended claims will also be apparent to the skilled person.

1. A body-wearable antenna system capable of operating in transmit and receive, comprising at least two antenna elements arranged to be mountable in a substantially equi-spaced distributed array around a user's body, wherein each antenna element is a directional type antenna and wherein the antenna system is configured, in use, such that the antenna elements operate in phase with each other to deliver a combined, higher gain, omnidirectional performance radiating away from the user's body, compared to one or more conventional body-worn omnidirectional antennas.

2. A body-wearable antenna system according to claim 1 wherein each antenna element is a planar type antenna comprising a radiating top plate and a ground plane.

3. A body-wearable antenna system according to claim 2 wherein each antenna element is a planar inverted-F antenna (PIFA).

4. A body-wearable antenna system according to claim 3 wherein the radiating top plate of each PIFA is triangular in shape.

5. A body-wearable antenna system according to claim 3 wherein at least one slot is provided in the radiating top plate of each PIFA.

6. A body-wearable antenna system according to claim 3 wherein at least one parasitic radiator is provided on the ground plane of each PIFA.

7. A body-wearable antenna system according to claim 2 wherein the ground plane of each antenna element is provided with mounting tabs.

8. A body-wearable antenna system according to claim 1 wherein each antenna element is provided with a protective radome.

9. A body-wearable antenna system according to claim 1 wherein each antenna element is flexible.

10. A body-wearable antenna system according to claim 1 wherein each antenna element is provided with an electrical conductor for electrically connecting the antenna element to a power source.

11. A body-wearable antenna system according to claim 1 comprising a power source electrically connected to a power divider, the power divider being electrically connected to the at least two antenna elements.

12. A body-wearable antenna system according to claim 1 further comprising one or more transceivers.

13. A body-wearable antenna system according to claim 1 further comprising a signal processor.

14. A garment incorporating a body-wearable antenna system according to claim 1 wherein the garment comprises at least a first and a second packet substantially equi-spaced around the garment for mounting the antenna elements in a distributed array.

15. (canceled)
